(19) United States
(12) Patent Application Publication
(10) Pub. No.: US 2026/0029896 A1
(43) Pub. Date: Jan. 29, 2026

(54) INFORMATION DISPLAY METHOD AND APPARATUS FOR AUDIOBOOK, ELECTRONIC DEVICE, AND STORAGE MEDIUM

(71) Applicant: Beijing Zitiao Network Technology Co., Ltd., Beijing (CN)

(72) Inventors: Yuanjun YANG, Beijing (CN); Rongqiang Huang, Beijing (CN); Guibo Pan, Beijing (CN)

(21) Appl. No.: 19/061,067

(22) Filed: Feb. 24, 2025

(30) Foreign Application Priority Data
Jul. 23, 2024 (CN) 202410993568.1

(51) Int. Cl. G06F 3/0483; G06F 3/0484; G06F 40/166; G06T 11/60

(52) U.S. Cl. CPC G06F 3/0483; G06F 3/0484; G06F 40/166; G06T 11/60; G06F 2203/04803

(57) ABSTRACT

Embodiments of the present disclosure provide an information display method and apparatus for an audiobook, an electronic device, and a storage medium. An audiobook player page is displayed in response to a trigger operation for a target audiobook on a content delivery page, where first content introduction information of the target audiobook is displayed in a first area of the audiobook player page, the first content introduction information including an introduction to key content of the target audiobook. Second content introduction information of the target audiobook is displayed in the first area of the audiobook player page in response to a first trigger operation for the audiobook player page, where the second content introduction information is an introduction to extended content of the target audiobook.

### CROSS-REFERENCE TO RELATED APPLICATION(S)

This application claims priority to Chinese Application No. 202410993568.1 filed Jul. 23, 2024, the disclosure of which is incorporated herein by reference in its entirety.

### FIELD

Embodiments of the present disclosure relate to the field of Internet technologies, and in particular, to an information display method and apparatus for an audiobook, an electronic device, and a storage medium.

### BACKGROUND

Currently, applications for audiobooks become increasingly popular among users due to their rich and diverse content resources. At the same time, though, one of the main optimization objectives of the applications is to guide users to find their favorite audiobook works more conveniently through more efficient interaction methods.

### SUMMARY

Embodiments of the present disclosure provide an information display method and apparatus for an audiobook, an electronic device, and a storage medium.

According to a first aspect, an embodiment of the present disclosure provides an information display method for an audiobook. The method includes:
displaying an audiobook player page in response to a trigger operation for a target audiobook on a content delivery page, where first content introduction information of the target audiobook is displayed in a first area of the audiobook player page, the first content introduction information including an introduction to key content of the target audiobook; displaying second content introduction information of the target audiobook in the first area of the audiobook player page in response to a first trigger operation for the audiobook player page, where the second content introduction information is an introduction to extended content of the target audiobook; and playing audio data of the target audiobook through the audiobook player page.

According to a second aspect, an embodiment of the present disclosure provides an information display apparatus for an audiobook. The apparatus includes:
a first response module configured to display an audiobook player page in response to a trigger operation for a target audiobook on a content delivery page, where first content introduction information of the target audiobook is displayed in a first area of the audiobook player page, the first content introduction information including an introduction to key content of the target audiobook;
a second response module configured to display second content introduction information of the target audiobook in the first area of the audiobook player page in response to a first trigger operation for the audiobook player page, where the second content introduction information is an introduction to extended content of the target audiobook; and a third response module configured to play audio data of the target audiobook through the audiobook player page.

According to a third aspect, an embodiment of the present disclosure provides an electronic device including: a processor and a memory, where the memory stores computer-executable instructions; and the processor executes the computer-executable instructions stored in the memory, to cause the processor to perform the information display method for an audiobook according to the first aspect and various possible designs of the first aspect.

According to a fourth aspect, an embodiment of the present disclosure provides a computer-readable storage medium. The computer-readable storage medium stores computer-executable instructions that, when executed by a processor, cause the information display method for an audiobook according to the first aspect and various possible designs of the first aspect to be implemented.

According to a fifth aspect, an embodiment of the present disclosure provides a computer program product including a computer program. When the computer program is executed by a processor, the information display method for an audiobook according to the first aspect and various possible designs of the first aspect is implemented.

### BRIEF DESCRIPTION OF THE DRAWINGS

In order to describe the technical solutions in embodiments of the present disclosure or in the prior art more clearly, the accompanying drawings for describing the embodiments or the prior art will be briefly described below. Apparently, the accompanying drawings in the description below display some embodiments of the present disclosure, and those of ordinary skill in the art may still derive other accompanying drawings from these accompanying drawings without creative efforts.

FIG. 1 is a diagram of an application scenario of an information display method for an audiobook according to an embodiment of the present disclosure;

FIG. 2 is a schematic flowchart 1 of an information display method for an audiobook according to an embodiment of the present disclosure;

FIG. 3 is a schematic diagram of a process for information display through an information card according to an embodiment of the present disclosure;

FIG. 4 is a schematic diagram of a process of displaying a role graph according to an embodiment of the present disclosure;

FIG. 5 is a schematic flowchart 2 of an information display method for an audiobook according to an embodiment of the present disclosure;

FIG. 6 is a flowchart of a specific implementation of step S203 in the embodiment shown in FIG. 5;

FIG. 7 is a schematic diagram of a process of displaying summary text according to an embodiment of the present disclosure;

FIG. 8 is a schematic diagram of a process of generating a role graph according to an embodiment of the present disclosure;

FIG. 9 is a block diagram of a structure of an information display apparatus for an audiobook according to an embodiment of the present disclosure;

FIG. 10 is a schematic diagram of a structure of an electronic device according to an embodiment of the present disclosure; and

FIG. 11 is a schematic diagram of a hardware structure of an electronic device according to an embodiment of the present disclosure.

### DETAILED DESCRIPTION OF EMBODIMENTS

In order to make the objectives, technical solutions, and advantages of embodiments of the present disclosure clearer, the technical solutions in the embodiments of the present disclosure will be described clearly and completely below with reference to the accompanying drawings in the embodiments of the present disclosure. Apparently, the embodiments described are some rather than all of the embodiments of the present disclosure. All other embodiments obtained by those of ordinary skill in the art based on the embodiments of the present disclosure without any creative effort shall fall within the scope of protection of the present disclosure.

It should be noted that user information (including but not limited to device information, personal information, etc., of a user) and data (including but not limited to data for analysis, stored data, displayed data, etc.) involved in the present disclosure are information and data for which an authorization is obtained from the user or a full authorization is obtained from each party, and the collection, use, and processing of relevant data need to comply with relevant laws, regulations, and standards of relevant countries and regions, for which corresponding operation entries are provided for the user to choose to authorize or deny.

In the prior art, when a user is on a content delivery page, a plurality of steps are required to find and play audiobook works of interest, resulting in the problem of low interaction efficiency which affects the user experience.

In the information display method and apparatus for an audiobook, the electronic device, and the storage medium according to the embodiments, the audiobook player page is displayed in response to the trigger operation for the target audiobook in the content delivery page, where the first content introduction information of the target audiobook is displayed in the first area of the audiobook player page, the first content introduction information including the introduction to the key content of the target audiobook. The second content introduction information of the target audiobook is displayed in the first area of the audiobook player page in response to the first trigger operation for the audiobook player page, where the second content introduction information is the introduction to the extended content of the target audiobook. The audio data of the target audiobook is played through the audiobook player page. By setting up a functional area with an operational interaction function on the audiobook player page, the display of the content of the target audiobook is implemented. In this way, after a user selects the target audiobook on the content delivery page, a terminal device can directly display the audiobook player page without additionally displaying a content introduction page of the target audiobook. This allows the user to listen to the audio data of the target audiobook while reading the introduction to the content of the target audiobook, thereby improving the interaction efficiency and user experience.

An application scenario of the embodiments of the present disclosure is described below.

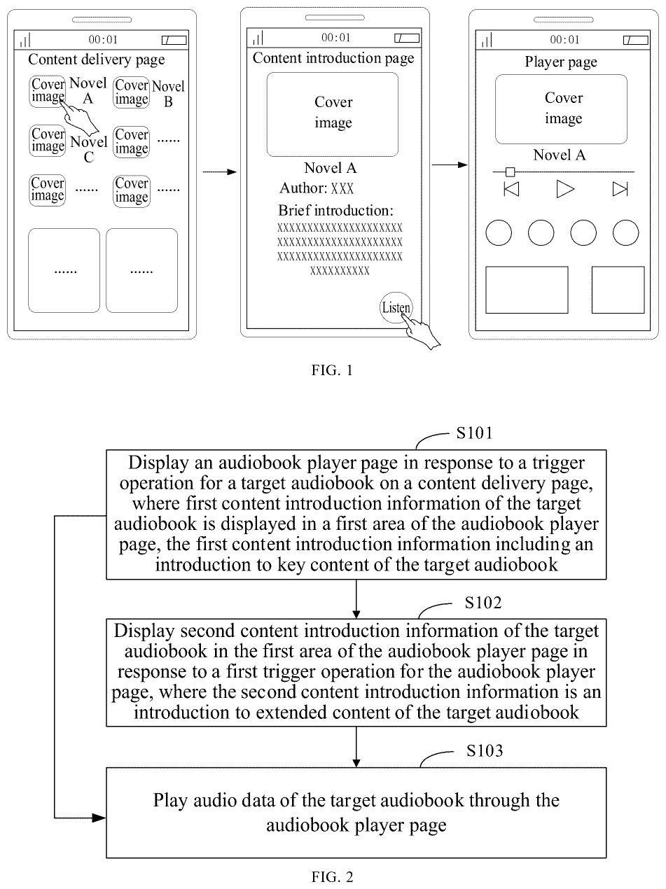

FIG. 1 is a diagram of an application scenario of an information display method for an audiobook according to an embodiment of the present disclosure. The information display method for an audiobook according to this embodiment of the present disclosure may be applied to an application, such as a book listening application or a novel application, that has an audiobook playback function. More specifically, the method may be applied to an application scenario in which an audiobook is played. An execution body of this embodiment may be a terminal device that runs the above application having an audiobook playback function, may be a server at a corresponding serving end at which the above application is deployed, or may be other electronic devices that have a similar function.

In some embodiments, the terminal device or the server may implement the information display method for an audiobook according to this embodiment of the present application by running various computer executable instructions or a computer program. For example, the computer executable instructions may be program-level commands, machine instructions, or software instructions. The computer program may be a native program or a software module in an operating system. It may be a local application, that is, a program that needs to be installed in the operating system to run, or may be an applet embedded into any APP, that is, a program that runs in a browser-based environment. To sum up, the above computer-executable instructions may be any form of instructions, and the above computer program may be any form of application, module, or plug-in. Their specific implementation forms may be configured as required. Further, in some embodiments, the server may be a stand-alone physical server, or a server cluster or a distributed system consisting of a plurality of physical servers, or a cloud server that provides basic cloud computing services, such as a cloud service, cloud storage, cloud communication, a cloud database, cloud computing, a cloud function, a network service, a middleware service, a domain name service, a security service, a content delivery network (CDN), and a big data and artificial intelligence platform. The cloud service may be an interactive processing service for the terminal device to call.

Referring to FIG. 1, the terminal device is used as an example. After running the above application having an audiobook playback function (hereinafter referred to as the application), the terminal device displays a content delivery page in the application. On the content delivery page, a plurality of optional audiobooks are displayed, such as a novel A, a novel B, and a novel C shown in the figure. Based on guidance of the content delivery page, a user may trigger any one of the above audiobooks, to further understand content of the audiobook. In the prior art, after the user triggers the audiobook, the terminal device navigates to a content introduction page. For example, as shown in the figure, after (a cover image of) the novel A is triggered, the terminal device navigates to the corresponding content introduction page. On the content introduction page, an author, a content introduction, comments, and other information about the novel A are displayed. Thereafter, the user continues to click a “listen” button on the content introduction page, and then the terminal device further navigates to a player page. On the player page, a function button is provided for implementing playback control. Through the above function button, playback control is performed on audio data of the audiobook, that is, the novel A.

As shown in FIG. 1, in the prior art, for the sake of display efficiency, the content delivery page typically only displays the names and cover images of audiobooks. Therefore, when the user triggers a corresponding audiobook work on the content delivery page, it is necessary to first navigate to a corresponding content introduction page to introduce the content of the audiobook. After that, the user needs to perform a further operation based on their personal preferences before navigating to a corresponding player page for audio playback. The above solution in the prior art causes the problem of low interaction efficiency. Especially in an audiobook application, when the user faces numerous audiobook resources, the foregoing interaction solution in the prior art increases the time consumption between selecting an audiobook and listening to its audio each time, thereby affecting the user experience.

An embodiment of the present disclosure provides an information display method for an audiobook, to solve the above problem.

Referring to FIG. 2, FIG. 2 is a schematic flowchart 1 of an information display method for an audiobook according to an embodiment of the present disclosure. The method in this embodiment may be applied to a terminal device. The information display method for an audiobook includes the following steps.

Step S101: Display an audiobook player page in response to a trigger operation for a target audiobook on a content delivery page, where first content introduction information of the target audiobook is displayed in a first area of the audiobook player page, the first content introduction information including an introduction to key content of the target audiobook.

Step S102: Display second content introduction information of the target audiobook in the first area of the audiobook player page in response to a first trigger operation for the audiobook player page, where the second content introduction information is an introduction to extended content of the target audiobook.

Step S103: Play audio data of the target audiobook through the audiobook player page.

For example, with reference to the schematic diagram of the application scenario shown in FIG. 1, after the terminal device runs an application, the application displays the content delivery page. Specifically, the content delivery page may be a home page of the application or any other secondary page, which is not limited here. On the content delivery page, the names, identifiers, cover images, etc., corresponding to audiobooks are provided. When a user inputs a trigger operation, such as clicking the name, identifier, or cover image corresponding to an audiobook, the terminal device performs a corresponding navigation action to display the audiobook player page. Subsequently, on the audiobook player page, a first area is provided for displaying first content introduction information of the target audiobook corresponding to the trigger operation. The first area of the audiobook player page has functions of information display and operational interaction. In a possible implementation, an information card is provided in the first area of the audiobook player page. The information card is a functional component embedded within the audiobook player page, and is capable of information display and operational interaction, meaning that it is capable of performing corresponding actions in response to the user's operations.

Further, the first content introduction information is the introduction to the key content of the target audiobook, where the key content is, for example, information such as the name, author, and theme type of the target audiobook. That is, the first content introduction information is used to display the key content of the target audiobook, enabling the user to learn about the key content of the target audiobook immediately after the terminal device displays the audiobook player page.

Further, after the audiobook player page is displayed, the user applies the first trigger operation to the first area based on an operational interaction capability of the first area. Subsequently, the terminal device displays second content introduction information of the target audiobook in the first area, where the second content introduction information is the introduction to the extended content of the target audiobook. Specifically, the extended content is, for example, a content introduction, a chapter plot introduction, a role introduction, etc. to the target audiobook. That is, through the first area, more detailed introduction information of the target audiobook can be displayed under further operations of the user.

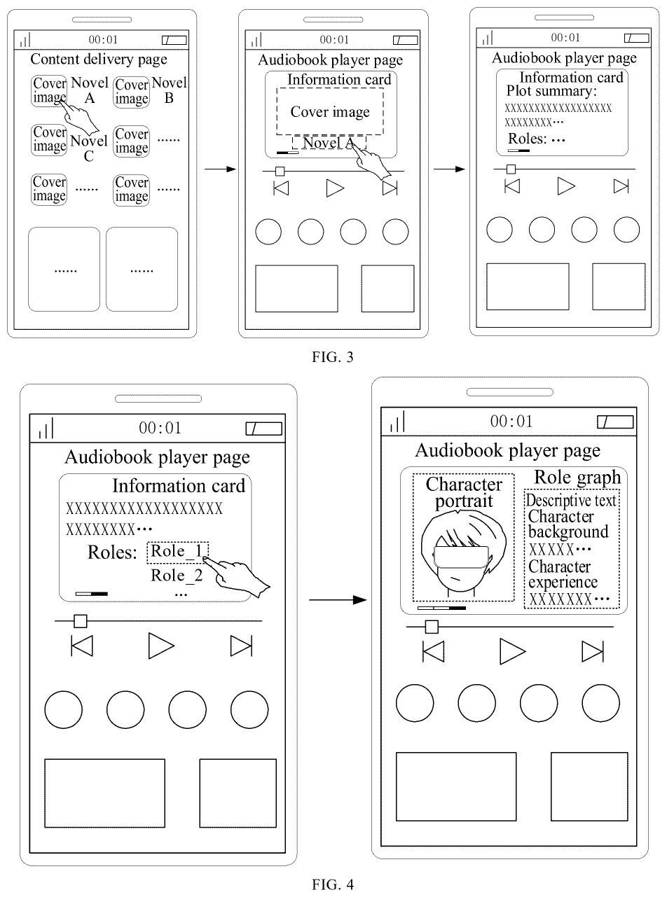

Further, in a possible implementation, the information card being provided in the first area is used as an example. The information card has at least two split-screen pages, where the first content introduction information is displayed on a first split-screen page of the information card, and the second content introduction information is displayed on a second split-screen page of the information card. FIG. 3 is a schematic diagram of a process for information display through an information card according to an embodiment of the present disclosure. The above process is further described below in conjunction with FIG. 3. As shown in FIG. 3, first, the audiobook player page is displayed in response to a click-to-select operation on a cover image of a novel A on the content delivery page. The upper portion of the audiobook player page is provided with the information card, while the lower portion of the audiobook player page is provided with a control button for playback control. On the first split-screen page of the information card, which is the default split-screen page, the name and cover image of the novel A are displayed, that is, the first content introduction information is displayed. Then, when the terminal device receives the first trigger operation applied by the user, for example, a click operation on the name of the novel A, the plot summary and roles of the novel A are displayed on the second split-screen page of the information card, that is, the second content introduction information is displayed. Further, when the second split-screen page cannot fully display the content of the second content introduction information, the undisplayed content can be displayed by means of enlarging the second split-screen page or scrolling the second split-screen page.

Further, in a possible implementation, role information for the target audiobook is further displayed on the second split-screen page of the information card, the role information being used to indicate a name of at least one virtual role in the target audiobook. With reference to the embodiment shown in FIG. 3, content of the role information is the roles displayed on the second split-screen page. In this embodiment, by providing the plurality of split-screen pages in the information card, the display of a plurality of pieces of content is implemented. Since the split-screen page can have effects on data preloading and data caching, fast alternate display between the plurality of split-screen pages is implemented. Therefore, fast alternate display between the first content introduction information and the second content introduction information can be implemented by providing the plurality of split-screen pages.

Certainly, in other implementations, only one page may also be provided in the information card, and a plurality of pieces of content are alternately displayed through a display-clear-display process.

After step S102, the method further includes the following step.

S102A: Display a role graph of a target virtual role in response to a second trigger operation for target role information on the second split-screen page.

The role graph contains at least one role image of the virtual role and at least one passage of descriptive text about the virtual role, the role image and the descriptive text being generated by processing text content of the target audiobook using a large model.

In a possible implementation, after the role information is displayed on the second split-screen page, the user may further apply the second trigger operation to a name or an identifier of a target virtual role (the target role information), to display the role graph of the target virtual role. The role graph may be displayed in the first area (for example, the information card), for example, the role graph is displayed on the third split-screen page of the information card. Alternatively, the role graph may be displayed at another position, for example, a new features page is navigated to display the role graph. The role graph contains the at least one role image of the virtual role and the at least one passage of descriptive text about the virtual role, where the role image is a character portrait of the target virtual role that is generated based on an AIGC technology; and the descriptive text is an introduction to the target virtual role that is generated based on the AIGC technology, such as a character background, a character relationship, or a character skill. The role graph is generated by processing the text content of the target audiobook using the large model. The role graph may be pre-generated, or may be generated in real time, which may be set as required.

Further, the descriptive text includes character relationship information, the character relationship information being used to represent a character relationship between the target virtual role and at least one non-target virtual role in the target audiobook. For example, the content of the character relationship information includes as follows: “The father of Role_1 is Role_2”.

FIG. 4 is a schematic diagram of a process of displaying a role graph according to an embodiment of the present disclosure. As shown in FIG. 4, for example, after the role information (including Role_1, Role_2, etc.) is displayed on the second split-screen page, the user applies a click-to-select operation (the second trigger operation) to “Role_1” (the target role information) thereon. Then, a role graph of Role_1 is displayed on the third split-screen page of the information card. Optionally, the user may further click the role graph on the third split-screen page to enlarge the role graph for display. The role graph includes a role image of the role Role_1 and descriptive text that describes a character background, character experience, character relationship, and other information about the role Role_1.

Further, the terminal device plays the audio data of the target audiobook through the audiobook player page. This step may be executed automatically, or may be manually triggered. In a possible implementation, for the automatic execution, the terminal device plays the audio data of the target audiobook immediately after displaying the audiobook player page, thereby implementing synchronous output of audio and a content introduction. In this case, the user can listen to the audio data of the selected target audiobook on a trial basis while watching the corresponding content introduction, thereby enabling the user to more efficiently learn about the content and quality of the target audiobook, and better determine whether to listen to the target audiobook, without having to read a work's introduction page and then listen to the audio data of the target audiobook on a trial basis. Therefore, the efficiency of the user for performing resource screening is improved. In another possible implementation, instead of playing the audio data of the target audiobook immediately after displaying the audiobook player page, the terminal device plays the audio data of the target audiobook after receiving a playback operation from the user. However, in this case, the terminal device may pre-cache the audio data such that it plays the audio data immediately after receiving the playback operation from the user, without having to wait for data to be downloaded. Therefore, the user experience is improved.

Based on the above descriptions, steps S102 and S103 in this embodiment may be performed synchronously or asynchronously. In a possible implementation, after step S101 has been performed, step S102 may be performed first and then step S103 may be performed, or step S103 may be performed first and then step S102 may be performed, or step S102 and step S103 may be performed simultaneously. This may be set as required.

In this embodiment, the audiobook player page is displayed in response to the trigger operation for the target audiobook on the content delivery page, where the first content introduction information of the target audiobook is displayed in the first area of the audiobook player page, the first content introduction information including the introduction to the key content of the target audiobook. Second content introduction information of the target audiobook is displayed in the first area of the audiobook player page in response to a first trigger operation for the audiobook player page, where the second content introduction information is an introduction to extended content of the target audiobook. Audio data of the target audiobook is played through the audiobook player page. By setting up a functional area with an operational interaction function on the audiobook player page, the display of the content of the target audiobook is implemented. In this way, after a user selects the target audiobook on the content delivery page, a terminal device can directly display the audiobook player page without additionally displaying a content introduction page of the target audiobook. This allows the user to listen to the audio data of the target audiobook while reading the introduction to the content of the target audiobook, thereby improving the interaction efficiency and user experience.

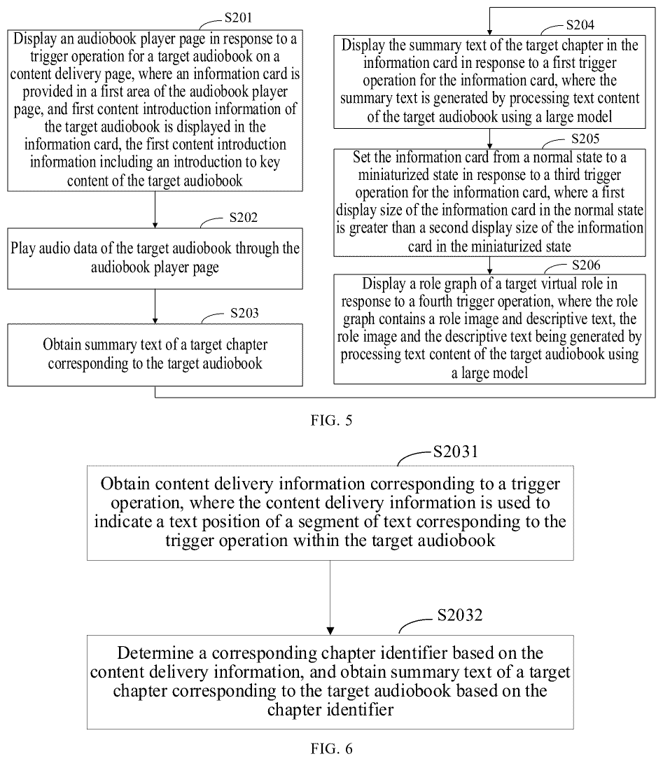

Referring to FIG. 5, FIG. 5 is a schematic flowchart 2 of an information display method for an audiobook according to an embodiment of the present disclosure. On the basis of the embodiment shown in FIG. 2, this embodiment further refines step S102, in which the audiobook player page is further configured to display the text content of the target audiobook. The information display method for an audiobook includes the following steps.

Step S201: Display the audiobook player page in response to a trigger operation for the target audiobook on a content delivery page, where an information card is provided in a first area of the audiobook player page, and first content introduction information of the target audiobook is displayed in the information card, the first content introduction information including an introduction to key content of the target audiobook.

For example, in this embodiment, the audiobook player page is further configured to display the text content of the target audiobook, that is, on the audiobook player page, part of an area is used to display the text content of the target audiobook. More specifically, the corresponding text content is synchronously displayed as audio data of the target audiobook is played. After the audiobook player page is displayed, the text content is displayed on the audiobook player page. In addition, the first content introduction information of the target audiobook is displayed in the information card of the audiobook player page.

Step S202: Play the audio data of the target audiobook through the audiobook player page.

Step S203: Obtain summary text of a target chapter corresponding to the target audiobook.

Further, after displaying the audiobook player page, a terminal device obtains the summary text of the target chapter corresponding to the target audiobook. Specifically, the text summary is the text that describes summary content. A summary, which can also be referred to as an overview or a content abstract, is a condensation and generalization of a long passage of text. The summary text in this embodiment is a condensation, generalization, and outline introduction of the content of the target audiobook. The text summary may be pre-configured for the target audiobook, or may be generated by processing the text content of the target audiobook through a large language model. In a possible implementation, in response to the first trigger operation for the audiobook player page, the terminal device displays the summary text (that is, second content introduction information) of the target audiobook in the information card, that is, a condensation, generalization, and outline introduction of the entire content of the target audiobook. In another possible implementation, the target audiobook includes a plurality of chapters, and different chapters have corresponding summary text. The terminal device first determines the target chapter based on the trigger operation, to obtain the summary text corresponding to the target chapter. Then, the terminal device displays the summary text corresponding to the target chapter in the information card in response to the first trigger operation for the audiobook player page.

For example, as shown in FIG. 6, the specific implementation of step S203 includes the following steps.

Step S2031: Obtain content delivery information corresponding to the trigger operation, where the content delivery information is used to indicate a text position of a segment of text corresponding to the trigger operation within the target audiobook.

Step S2032: Determine a corresponding chapter identifier based on the content delivery information, and obtain summary text of a target chapter corresponding to the target audiobook based on the chapter identifier.

For example, in a possible implementation, on the content delivery page, in addition to displaying the names and/or the cover images of audiobooks, chapter information or highlighted content is also correspondingly displayed. Specifically, the content of the chapter information is, for example, “Updated to Chapter 102”. In this case, when the trigger operation for the target audiobook on the content delivery page is a trigger operation for the above chapter information, the terminal device obtains the content delivery information based on the chapter information triggered by the trigger operation. The content delivery information represents the text position of “Chapter 102”. The highlighted content is, for example, a passage, more specifically, a wonderful paragraph or a highly commented sentence in the audiobook, for example. In this case, when the trigger operation for the target audiobook on the content delivery page is a trigger operation for the above highlighted content, the terminal device obtains the content delivery information based on a position of the highlighted content, that is, a text position of a segment of text corresponding to the highlighted content within the target audiobook.

Thereafter, a chapter identifier of a chapter at the position is determined based on the content delivery information, and then the summary text of the target chapter corresponding to the target audiobook is obtained based on the chapter identifier. For example, the summary text is pre-generated text, and the chapter identifier has a mapping relationship with the summary text of the corresponding target chapter. The terminal device obtains the summary text of the corresponding target chapter according to the mapping relationship and the chapter identifier.

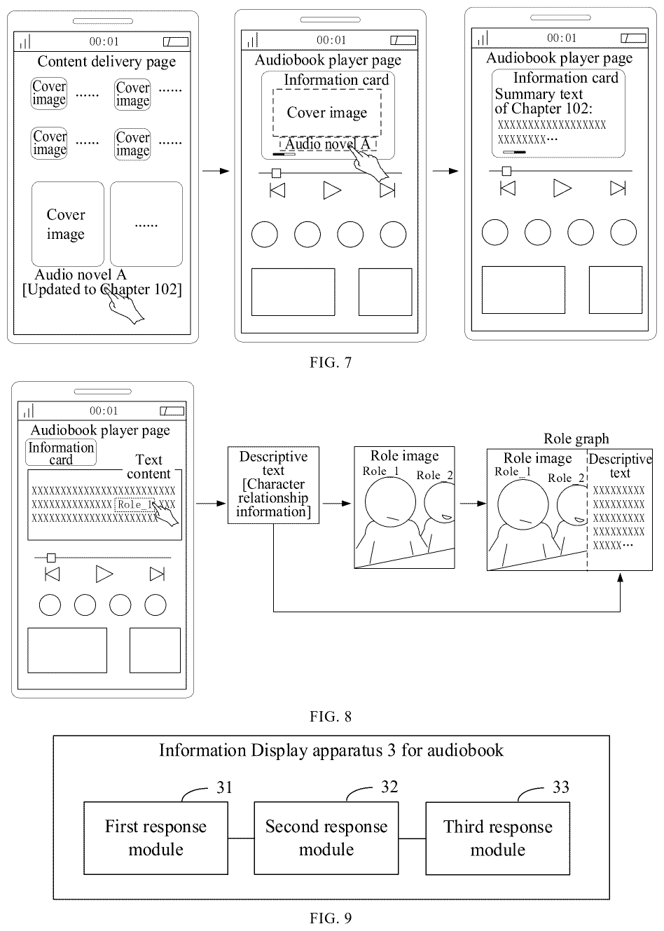

FIG. 7 is a schematic diagram of a process of displaying summary text according to an embodiment of the present disclosure. As shown in FIG. 7, a name, a cover image, and chapter information of an audio novel A are displayed on a content delivery page, where the content of the chapter information is “Updated to Chapter 102”. After a user clicks on the chapter information of the audio novel A, a terminal device first navigates to an audiobook player page to display the audiobook player page, and then displays the cover image and name (first content introduction information) of the target audiobook in an information card of the audiobook player page. Then, the user further clicks on the name of the target audiobook (a first trigger operation), and the terminal device displays summary text (second content introduction information) of Chapter 102 of the audio novel A in the information card.

Step S204: Display summary text of a target chapter in the information card in response to the first trigger operation for the information card, where the summary text is generated by processing text content of the target audiobook using a large model.

For example, thereafter, the user applies the first trigger operation to the information card, and the terminal device displays the summary text of the target chapter obtained in the above step in the information card in response to the first trigger operation, thereby implementing the display of the summary text of the specific chapter. Through the above step, refined control over the content of the summary text may be implemented, which allows the user to clearly learn about content of each chapter of the audiobook through the information card, or content of a chapter in which highlighted content is located. Therefore, the efficiency and effect for information display through the information card are improved.

Further, for example, the summary text has a target font and/or a target background color, the target font and/or the target background color being determined based on a theme type of the target audiobook. That is, before displaying the summary text in the information card, the terminal device determines the corresponding target font and/or the corresponding target background color based on the theme type of the target audiobook, and then displays the summary text in the information card based on the target font and/or target background color, so that a posture and a background color of the summary text match the theme type corresponding to the summary text. Therefore, the sense of immersion during information display is improved, and the user experience is thus improved.

Step S205: Set the information card from a normal state to a miniaturized state in response to a third trigger operation for the information card, where a first display size of the information card in the normal state is greater than a second display size of the information card in the miniaturized state.

For example, further, in a case where the audiobook player page is further configured to display text content of the target audiobook, after the above operation for the information card is performed, an information display task of the information card is completed. In this case, the user may set the information card from the normal state to the miniaturized state by performing the third trigger operation for the information card. The display size of the information card in the miniaturized state is less than the display size of the information card in the normal state, which allows the information card to be collapsed, thereby avoiding its impact on the display of the text content.

Step S206: Display a role graph of a target virtual role in response to a fourth trigger operation, where the role graph contains a role image and descriptive text, the role image and the descriptive text being generated by processing text content of the target audiobook using a large model

For example, further, the terminal device may further display the role graph of the target virtual role in response to the fourth trigger operation. The fourth trigger operation may be implemented in a variety of manners. For example, in the information card (for example, on a second split-screen page displayed in response to the first trigger operation), role information for the target audiobook is further displayed. The role information may be used to indicate the name of at least one virtual role in the target audiobook, for example, including Role_1 or Role_2. The role information may also be displayed in the form of a card component. The card component is a display component for displaying an image and text. The card component for displaying the role information may also be referred to as a role card. The fourth trigger operation is a click operation on the name of the virtual role or a trigger operation on the role card. For another example, during display of the text content of the target audiobook on the audiobook player page, when the name of the virtual role appears in the displayed text content, the fourth trigger operation is the click operation on the name of the above virtual role. That is, after a specific target virtual role is selected through the fourth trigger operation, the terminal device generates and displays a role graph corresponding to the target virtual role. The role graph contains a role image and descriptive text. The role image is a character portrait for the target virtual role, and the descriptive text is a text introduction to the target virtual role.

In a possible implementation, the descriptive text is used to represent a character relationship between the target virtual role and at least one non-target virtual role in the target audiobook. For example, the content of the descriptive text includes as follows: “The pet of Role_1 is Role_2”. The role image is generated based on the descriptive text. Therefore, the role image contains the target virtual role and the at least one non-target virtual role that is determined based on the descriptive text. For example, both Role_1 and Role_2 are included. The role graph may be generated on a terminal device side, or may be generated on a server side and then sent to the terminal device for display. The role graph being generated on the terminal device side is used as an example. When processing the text content of the target audiobook by calling a large language model, the terminal device first generates the descriptive text, uses the descriptive text as reference information (for example, generates a corresponding prompt word), and then calls a large text-to-image generation model to process the text content of the target audiobook, so as to generate the above role image including the target virtual role and the non-target virtual role that have the character relationship. In this case, the generated role graph is capable of displaying the character relationship, thereby improving the efficiency and effect of information display.

FIG. 8 is a schematic diagram of a process of generating a role graph according to an embodiment of the present disclosure. Referring to FIG. 8, first, an information card is in a miniaturized state, and text content of a target audiobook (for example, an audio novel A) is displayed on an audiobook player page. Thereafter, a terminal device receives a fourth trigger operation. The fourth trigger operation is an operation of selecting a target virtual role from the text content of the target audiobook, for example, as shown in the figure, selecting Role_1 as the target virtual role. Thereafter, by calling a large language model, descriptive text corresponding to Role_1 is obtained. The descriptive text contains character relationship information, the character relationship information indicating another non-target virtual role Role_2 that has a character relationship with the target virtual role Role_1. Thereafter, a role image is generated based on the descriptive text. The role image includes both the above target virtual role Role_1 and non-target virtual role Role_2. Finally, the role image and the descriptive text are combined to generate the role graph.

In this embodiment, the implementations of steps S201 and S202 are the same as the implementations of steps S101 and S103 in the embodiment shown in FIG. 2 of the present disclosure. Details are not repeated herein.

Corresponding to the information display method for an audiobook in the above embodiment, FIG. 9 is a block diagram of a structure of an information display apparatus for an audiobook according to an embodiment of the present disclosure. The method described in the above embodiment may be performed by the information display apparatus for an audiobook. The apparatus may be implemented by software and/or hardware, and may be integrated into an electronic device having a certain data processing function. The electronic device may include, but is not limited to, a mobile terminal with a big data processing capability, and a fixed terminal with a big data processing capability such as a desktop computer and a supercomputer.

For ease of illustration, only parts related to this embodiment of the present disclosure are shown. Referring to FIG. 9, the information display apparatus 3 for an audiobook includes: a first response module 31 configured to display an audiobook player page in response to a trigger operation for a target audiobook on a content delivery page, where first content introduction information of the target audiobook is displayed in a first area of the audiobook player page, the first content introduction information including an introduction to key content of the target audiobook;
a second response module 32 configured to display second content introduction information of the target audiobook in the first area of the audiobook player page in response to a first trigger operation for the audiobook player page, where the second content introduction information is an introduction to extended content of the target audiobook; and
a third response module 33 configured to play audio data of the target audiobook through the audiobook player page.

According to one or more embodiments of the present disclosure, an information card is provided in the first area of the audiobook player page, the information card having at least two split-screen pages, where the first content introduction information is displayed on a first split-screen page of the information card. When displaying second content introduction information of the target audiobook in the first area of the audiobook player page, the second response module 32 is specifically configured to: display the second content introduction information on a second split-screen page of the information card.

According to one or more embodiments of the present disclosure, role information for the target audiobook is further displayed on the second split-screen page of the information card, the role information being used to indicate a name of at least one virtual role in the target audiobook. The second response module 32 is further configured to: display a role graph of a target virtual role in response to a second trigger operation for target role information on the second split-screen page, where the role graph contains at least one role image of the virtual role and at least one passage of descriptive text about the virtual role, the role image and the descriptive text being generated by processing text content of the target audiobook using a large model.

According to one or more embodiments of the present disclosure, the descriptive text includes character relationship information, the character relationship information being used to represent a character relationship between the target virtual role and at least one non-target virtual role in the target audiobook.

According to one or more embodiments of the present disclosure, when displaying second content introduction information of the target audiobook in the first area of the audiobook player page, the second response module 32 is specifically configured to: display summary text of the target audiobook in the first area of the audiobook player page, where the summary text is generated by processing text content of the target audiobook using a large model, and the summary text has a target font and/or a target background color, the target font and/or the target background color being determined based on a theme type of the target audiobook.

According to one or more embodiments of the present disclosure, a segment of text of the target audiobook is displayed on the content delivery page. Before the displaying summary text of the target audiobook in the first area of the audiobook player page, the second response module 32 is further configured to: obtain content delivery information corresponding to the trigger operation, where the content delivery information is used to indicate a text position of a segment of text corresponding to the trigger operation within the target audiobook; and determine a corresponding chapter identifier based on the content delivery information, and obtain summary text of a target chapter corresponding to the target audiobook based on the chapter identifier. When displaying summary text of the target audiobook in the first area of the audiobook player page, the second response module 32 is specifically configured to: display the summary text of the target chapter in the first area of the audiobook player page.

According to one or more embodiments of the present disclosure, the audiobook player page is further configured to display the text content of the target audiobook. The second response module 32 is further configured to: set the information card from a normal state to a miniaturized state in response to a third trigger operation for the information card, where a first display size of the information card in the normal state is greater than a second display size of the information card in the miniaturized state.

According to one or more embodiments of the present disclosure, the second response module 32 is further configured to: display a role graph of a target virtual role in response to a fourth trigger operation, where the role graph includes a role image and descriptive text, the role image and the descriptive text being generated by processing text content of the target audiobook using a large model, where the descriptive text is used to represent a character relationship between the target virtual role and at least one non-target virtual role in the target audiobook, and the role image contains the target virtual role and the at least one non-target virtual role that is determined based on the descriptive text.

The first response module 31, the second response module 32, and the third response module 33 are connected in sequence. The information display apparatus 3 for an audiobook according to this embodiment may perform the technical solution of the above method embodiment. The implementation principles and technical effects thereof are similar, which are not repeated in this embodiment.

FIG. 10 is a schematic diagram of a structure of an electronic device according to an embodiment of the present disclosure. As shown in FIG. 10, an electronic device 4 includes: a processor 41, and a memory 42 communicatively connected to the processor 41.

The memory 42 stores computer-executable instructions.

The processor 41 executes the computer-executable instructions stored in the memory 42 to implement the information display method for an audiobook according to the embodiments shown in FIG. 2 to FIG. 8.

Optionally, the processor 41 is connected to the memory 42 through a bus 43.

The related illustration may be understood with reference to related descriptions and effects that correspond to the steps in the embodiments corresponding to FIG. 2 to FIG. 8. Details are not repeated herein.

An embodiment of the present disclosure provides a computer-readable storage medium. The computer-readable storage medium stores computer-executable instructions that, when executed by a processor, are used to implement the information display method for an audiobook according to any one of the embodiments corresponding to FIG. 2 to FIG. 8 of the present disclosure.

An embodiment of the present disclosure provides a computer program product, including a computer program. When the computer program is executed by a processor, the information display method for an audiobook according to any one of the embodiments corresponding to FIG. 2 to FIG. 8 of the present disclosure is implemented.

To implement the above embodiments, an embodiment of the present disclosure further provides an electronic device.

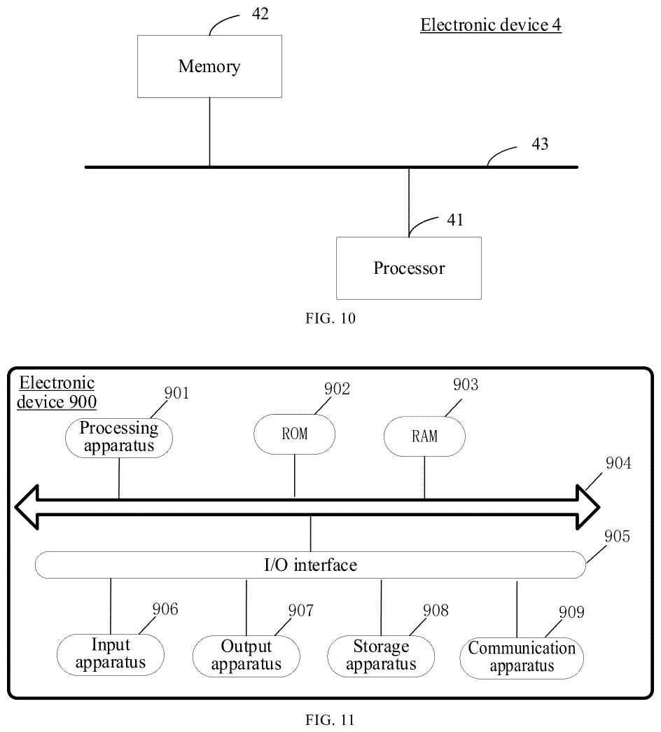

FIG. 11 is a schematic diagram of a structure of an electronic device 900 suitable for implementing the embodiments of the present disclosure. The electronic device 900 may be a terminal device or a server. The terminal device may include, but is not limited to, a mobile terminal such as a mobile phone, a notebook computer, a digital broadcast receiver, a personal digital assistant (PDA), a tablet computer (portable Android device, PAD), a portable media player (PMP), and a vehicle-mounted terminal (such as a vehicle navigation terminal), and a fixed terminal such as a digital TV and a desktop computer. The electronic device shown in FIG. 11 is merely an example, and shall not impose any limitation on the function and scope of use of the embodiments of the present disclosure.

As shown in FIG. 11, the electronic device 900 may include a processing apparatus (such as a central processing unit or a graphics processing unit) 901 that may perform a variety of appropriate actions and processing in accordance with a program stored in a read-only memory (ROM) 902 or a program loaded from a storage apparatus 908 into a random access memory (RAM) 903. The RAM 903 further stores various programs and data required for the operation of the electronic device 900. The processing apparatus 901, the ROM 902, and the RAM 903 are connected to one another through a bus 904. An input/output (I/O) interface 905 is also connected to the bus 904.

Generally, the following apparatuses may be connected to the I/O interface 905: an input apparatus 906 including, for example, a touchscreen, a touchpad, a keyboard, a mouse, a camera, a microphone, an accelerometer, and a gyroscope; an output apparatus 907 including, for example, a liquid crystal display (LCD), a speaker, and a vibrator; the storage apparatus 908 including, for example, a tape and a hard disk; and a communication apparatus 909. The communication apparatus 909 may allow the electronic device 900 to perform wireless or wired communication with other devices to exchange data. Although FIG. 11 shows the electronic device 900 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded and installed from a network through the communication apparatus 909, installed from the storage apparatus 908, or installed from the ROM 902. When the computer program is executed by the processing apparatus 901, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to perform the method shown in the above embodiment.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user via any kind of network, including a local area network (LAN) or a wide area network (WAN), or may be connected to an external computer (for example, connected via the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units or modules described in the embodiments of the present disclosure may be implemented by software, or may be implemented by hardware. The name of the unit or module does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

In a first aspect, according to one or more embodiments of the present disclosure, there is provided an information display method for an audiobook. The method includes:
displaying an audiobook player page in response to a trigger operation for a target audiobook on a content delivery page, where first content introduction information of the target audiobook is displayed in a first area of the audiobook player page, the first content introduction information including an introduction to key content of the target audiobook; displaying second content introduction information of the target audiobook in the first area of the audiobook player page in response to a first trigger operation for the audiobook player page, where the second content introduction information is an introduction to extended content of the target audiobook; and playing audio data of the target audiobook through the audiobook player page.

According to one or more embodiments of the present disclosure, an information card is provided in the first area of the audiobook player page, the information card having at least two split-screen pages, where the first content introduction information is displayed on a first split-screen page of the information card. The displaying second content introduction information of the target audiobook in the first area of the audiobook player page includes: displaying the second content introduction information on a second split-screen page of the information card.

According to one or more embodiments of the present disclosure, role information for the target audiobook is further displayed on the second split-screen page of the information card, the role information being used to indicate a name of at least one virtual role in the target audiobook. The method further includes: displaying a role graph of a target virtual role in response to a second trigger operation for target role information on the second split-screen page, where the role graph contains at least one role image of the virtual role and at least one passage of descriptive text about the virtual role, the role image and the descriptive text being generated by processing text content of the target audiobook using a large model.

According to one or more embodiments of the present disclosure, the descriptive text includes character relationship information, the character relationship information being used to represent a character relationship between the target virtual role and at least one non-target virtual role in the target audiobook.

According to one or more embodiments of the present disclosure, the displaying second content introduction information of the target audiobook in the first area of the audiobook player page includes: displaying summary text of the target audiobook in the first area of the audiobook player page, where the summary text is generated by processing text content of the target audiobook using a large model, and the summary text has a target font and/or a target background color, the target font and/or the target background color being determined based on a theme type of the target audiobook.

According to one or more embodiments of the present disclosure, a segment of text of the target audiobook is displayed on the content delivery page. Before the displaying summary text of the target audiobook in the first area of the audiobook player page, the method further includes: obtaining content delivery information corresponding to the trigger operation, where the content delivery information is used to indicate a text position of a segment of text corresponding to the trigger operation within the target audiobook; and determining a corresponding chapter identifier based on the content delivery information, and obtaining summary text of a target chapter corresponding to the target audiobook based on the chapter identifier. The displaying summary text of the target audiobook in the first area of the audiobook player page includes: displaying the summary text of the target chapter in the first area of the audiobook player page.

According to one or more embodiments of the present disclosure, the audiobook player page is further configured to display text content of the target audiobook. The method further includes: setting the information card from a normal state to a miniaturized state in response to a third trigger operation for the information card, where a first display size of the information card in the normal state is greater than a second display size of the information card in the miniaturized state.

According to one or more embodiments of the present disclosure, the method further includes: displaying a role graph of a target virtual role in response to a fourth trigger operation, where the role graph includes a role image and descriptive text, the role image and the descriptive text being generated by processing text content of the target audiobook using a large model, where the descriptive text is used to represent a character relationship between the target virtual role and at least one non-target virtual role in the target audiobook, and the role image contains the target virtual role and the at least one non-target virtual role that is determined based on the descriptive text.

In a second aspect, according to one or more embodiments of the present disclosure, an information display apparatus for an audiobook is provided. The apparatus includes:
a first response module configured to display an audiobook player page in response to a trigger operation for a target audiobook on a content delivery page, where an information card is provided on the audiobook player page, and first content introduction information of the target audiobook is displayed in the information card, the first content introduction information including an introduction to key content of the target audiobook;
a second response module configured to display second content introduction information of the target audiobook in the first area of the audiobook player page in response to a first trigger operation for the audiobook player page, where the second content introduction information is an introduction to extended content of the target audiobook; and
a third response module configured to play audio data of the target audiobook through the audiobook player page.

According to one or more embodiments of the present disclosure, the information card has at least two split-screen pages, where the first content introduction information is displayed on a first split-screen page of the information card. When displaying second content introduction information of the target audiobook in the first area of the audiobook player page, the second response module is specifically configured to: present the second content introduction information on a second split-screen page of the information card.

According to one or more embodiments of the present disclosure, role information for the target audiobook is further displayed on the second split-screen page of the information card, the role information being used to indicate a name of at least one virtual role in the target audiobook. The second response module is further configured to: display a role graph of a target virtual role in response to a second trigger operation for target role information on the second split-screen page, where the role graph contains at least one role image of the virtual role and at least one passage of descriptive text about the virtual role, the role image and the descriptive text being generated by processing text content of the target audiobook using a large model.

According to one or more embodiments of the present disclosure, the descriptive text includes character relationship information, the character relationship information being used to represent a character relationship between the target virtual role and at least one non-target virtual role in the target audiobook.

According to one or more embodiments of the present disclosure, when displaying second content introduction information of the target audiobook in the first area of the audiobook player page, the second response module is specifically configured to: display summary text of the target audiobook in the first area of the audiobook player page, where the summary text is generated by processing text content of the target audiobook using a large model, and the summary text has a target font and/or a target background color, the target font and/or the target background color being determined based on a theme type of the target audiobook.

According to one or more embodiments of the present disclosure, a segment of text of the target audiobook is displayed on the content delivery page. Before the displaying summary text of the target audiobook in the first area of the audiobook player page, the second response module is further configured to: obtain content delivery information corresponding to the trigger operation, where the content delivery information is used to indicate a text position of a segment of text corresponding to the trigger operation within the target audiobook; and determine a corresponding chapter identifier based on the content delivery information, and obtain summary text of a target chapter corresponding to the target audiobook based on the chapter identifier; and When displaying summary text of the target audiobook in the first area of the audiobook player page, the second response module is specifically configured to: display the summary text of the target chapter in the first area of the audiobook player page.

According to one or more embodiments of the present disclosure, the audiobook player page is further configured to display text content of the target audiobook. The second response module is further configured to: set the information card from a normal state to a miniaturized state in response to a third trigger operation for the information card, where a first display size of the information card in the normal state is greater than a second display size of the information card in the miniaturized state.

According to one or more embodiments of the present disclosure, the second response module is further configured to: display a role graph of a target virtual role in response to a fourth trigger operation, where the role graph includes a role image and descriptive text, the role image and the descriptive text being generated by processing text content of the target audiobook using a large model, where the descriptive text is used to represent a character relationship between the target virtual role and at least one non-target virtual role in the target audiobook, and the role image contains the target virtual role and the at least one non-target virtual role that is determined based on the descriptive text.

In a third aspect, according to one or more embodiments of the present disclosure, an electronic device is provided. The electronic device includes: at least one processor and a memory.

The memory stores computer-executable instructions.

The at least one processor executes the computer-executable instructions stored in the memory, to cause the at least one processor to perform the information display method for an audiobook according to the first aspect and various possible designs of the first aspect.

In a fourth aspect, according to one or more embodiments of the present disclosure, a computer-readable storage medium is provided. The computer-readable storage medium stores computer-executable instructions that, when executed by a processor, cause the information display method for an audiobook according to the first aspect and various possible designs of the first aspect to be implemented.

In a fifth aspect, according to one or more embodiments of the present disclosure, a computer program product including a computer program is provided. When the computer program is executed by a processor, the information display method for an audiobook according to the first aspect and various possible designs of the first aspect is implemented.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/We claim:

1. An information display method for an audiobook, comprising:
displaying an audiobook player page in response to a trigger operation for a target audiobook on a content delivery page, first content introduction information of the target audiobook being displayed in a first area of the audiobook player page, the first content introduction information comprising an introduction to key content of the target audiobook;
displaying second content introduction information of the target audiobook in the first area of the audiobook player page in response to a first trigger operation for the audiobook player page, wherein the second content introduction information is an introduction to extended content of the target audiobook; and
playing audio data of the target audiobook through the audiobook player page.

2. The information display method according to claim 1, wherein an information card is provided in the first area of the audiobook player page, the information card has at least two split-screen pages, the first content introduction information is displayed on a first split-screen page of the information card, and displaying the second content introduction information of the target audiobook in the first area of the audiobook player page comprises:
displaying the second content introduction information on a second split-screen page of the information card.

3. The information display method according to claim 2, wherein role information for the target audiobook is further displayed on the second split-screen page of the information card, the role information is used to indicate a name of at least one virtual role in the target audiobook; and
the method further comprises:
displaying a role graph of a target virtual role in response to a second trigger operation for target role information on the second split-screen page, wherein the role graph contains at least one role image of the virtual role and at least one descriptive text for the virtual role, the role image and the descriptive text are generated by processing text content of the target audiobook using a large model.

4. The information display method according to claim 3, wherein the descriptive text comprises character relationship information, the character relationship information is used to represent a character relationship between the target virtual role and at least one non-target virtual role in the target audiobook.

5. The information display method according to claim 1, wherein displaying the second content introduction information of the target audiobook in the first area of the audiobook player page comprises:
displaying summary text of the target audiobook in the first area of the audiobook player page, wherein the summary text is generated by processing text content of the target audiobook using a large model, the summary text has a target font and/or a target background color, and the target font and/or the target background color are determined based on a theme type of the target audiobook.

6. The information display method according to claim 5, wherein a segment of text of the target audiobook is displayed on the content delivery page, and before displaying summary text of the target audiobook in the first area of the audiobook player page, the method further comprises:
obtaining content delivery information corresponding to the trigger operation, the content delivery information being used to indicate a text position of a segment of text corresponding to the trigger operation within the target audiobook; and
determining a corresponding chapter identifier based on the content delivery information, and obtaining summary text of a target chapter corresponding to the target audiobook based on the chapter identifier; and
wherein displaying the summary text of the target audiobook in the first area of the audiobook player page comprises:
displaying the summary text of the target chapter in the first area of the audiobook player page.

7. The information display method according to claim 2, wherein the audiobook player page is further configured to display text content of the target audiobook; and
the method further comprises:
setting the information card from a normal state to a miniaturized state in response to a third trigger operation for the information card, wherein a first display size of the information card in the normal state is greater than a second display size of the information card in the miniaturized state.

8. The information display method according to claim 1, wherein the method further comprises:
displaying a role graph of a target virtual role in response to a fourth trigger operation, the role graph comprising a role image and descriptive text, the role image and the descriptive text being generated by processing text content of the target audiobook using a large model,
wherein the descriptive text is used to represent a character relationship between the target virtual role and at least one non-target virtual role in the target audiobook, and the role image contains the target virtual role and the at least one non-target virtual role that is determined based on the descriptive text.

9. An electronic device, comprising: a processor and a memory,
wherein the memory stores computer-executable instructions; and
the computer-executable instructions that, when executed by the processor, cause the electronic device to:
display an audiobook player page in response to a trigger operation for a target audiobook on a content delivery page, wherein first content introduction information of the target audiobook is displayed in a first area of the audiobook player page, and the first content introduction information comprises an introduction to key content of the target audiobook;
display second content introduction information of the target audiobook in the first area of the audiobook player page in response to a first trigger operation for the audiobook player page, wherein the second content introduction information is an introduction to extended content of the target audiobook; and
play audio data of the target audiobook through the audiobook player page.

10. The electronic device according to claim 9, wherein an information card is provided in the first area of the audiobook player page, the information card has at least two split-screen pages, the first content introduction information is displayed on a first split-screen page of the information card, and the computer-executable instructions causing the electronic device to display the second content introduction information of the target audiobook in the first area of the audiobook player page further cause the electronic device to:
display the second content introduction information on a second split-screen page of the information card.

11. The electronic device according to claim 10, wherein role information for the target audiobook is further displayed on the second split-screen page of the information card, the role information is used to indicate a name of at least one virtual role in the target audiobook; and
the computer-executable instructions further cause the electronic device to:
display a role graph of a target virtual role in response to a second trigger operation for target role information on the second split-screen page, wherein the role graph contains at least one role image of the virtual role and at least one descriptive text for the virtual role, the role image and the descriptive text are generated by processing text content of the target audiobook using a large model.

12. The electronic device according to claim 11, wherein the descriptive text comprises character relationship information, the character relationship information is used to represent a character relationship between the target virtual role and at least one non-target virtual role in the target audiobook.

13. The electronic device according to claim 9, wherein the computer-executable instructions causing the electronic device to display the second content introduction information of the target audiobook in the first area of the audiobook player page further cause the electronic device to:
display summary text of the target audiobook in the first area of the audiobook player page, wherein the summary text is generated by processing text content of the target audiobook using a large model, the summary text has a target font and/or a target background color, and the target font and/or the target background color are determined based on a theme type of the target audiobook.

14. The electronic device according to claim 13, wherein a segment of text of the target audiobook is displayed on the content delivery page, and before the computer-executable instructions causing the electronic device to display summary text of the target audiobook in the first area of the audiobook player page, the computer-executable instructions further cause the electronic device to:
obtain content delivery information corresponding to the trigger operation, wherein the content delivery information is used to indicate a text position of a segment of text corresponding to the trigger operation within the target audiobook; and
determine a corresponding chapter identifier based on the content delivery information, and obtain summary text of a target chapter corresponding to the target audiobook based on the chapter identifier; and
wherein the computer-executable instructions causing the electronic device to display the summary text of the target audiobook in the first area of the audiobook player page further cause the electronic device to:
display the summary text of the target chapter in the first area of the audiobook player page.

15. The electronic device according to claim 10, wherein the audiobook player page is further configured to display text content of the target audiobook; and
the computer-executable instructions further cause the electronic device to:
set the information card from a normal state to a miniaturized state in response to a third trigger operation for the information card, wherein a first display size of the information card in the normal state is greater than a second display size of the information card in the miniaturized state.

16. The electronic device according to claim 9, wherein the computer-executable instructions further cause the electronic device to:
display a role graph of a target virtual role in response to a fourth trigger operation, wherein the role graph comprises a role image and descriptive text, and the role image and the descriptive text are generated by processing text content of the target audiobook using a large model,
wherein the descriptive text is used to represent a character relationship between the target virtual role and at least one non-target virtual role in the target audiobook, and the role image contains the target virtual role and the at least one non-target virtual role that is determined based on the descriptive text.

17. A non-transitory computer-readable storage medium, storing computer-executable instructions that, when executed by a processor, cause the processor to:
display an audiobook player page in response to a trigger operation for a target audiobook on a content delivery page, wherein first content introduction information of the target audiobook is displayed in a first area of the audiobook player page, and the first content introduction information comprises an introduction to key content of the target audiobook;
display second content introduction information of the target audiobook in the first area of the audiobook player page in response to a first trigger operation for the audiobook player page, wherein the second content introduction information is an introduction to extended content of the target audiobook; and
play audio data of the target audiobook through the audiobook player page.

18. The non-transitory computer-readable storage medium according to claim 17, wherein an information card is provided in the first area of the audiobook player page, the information card has at least two split-screen pages, the first content introduction information is displayed on a first split-screen page of the information card, and the computer-executable instructions causing the processor to display the second content introduction information of the target audiobook in the first area of the audiobook player page further cause the processor to:
display the second content introduction information on a second split-screen page of the information card.

19. The non-transitory computer-readable storage medium according to claim 18, wherein role information for the target audiobook is further displayed on the second split-screen page of the information card, the role information is used to indicate a name of at least one virtual role in the target audiobook; and
the computer-executable instructions further cause the processor to:
display a role graph of a target virtual role in response to a second trigger operation for target role information on the second split-screen page, wherein the role graph contains at least one role image of the virtual role and at least one descriptive text for the virtual role, the role image and the descriptive text are generated by processing text content of the target audiobook using a large model.

20. The non-transitory computer-readable storage medium according to claim 19, wherein the descriptive text comprises character relationship information, the character relationship information is used to represent a character relationship between the target virtual role and at least one non-target virtual role in the target audiobook.
